(19) United States
(12) Patent Application Publication
(10) Pub. No.: US 2024/0064261 A1
(43) Pub. Date: Feb. 22, 2024

(54) COLOR MAPPINGS

(71) Applicant: Hewlett-Packard Development Company, L.P., Spring, TX (US)

(72) Inventors: Peter Morovic, Sant Cugat del Valles (ES); Jan Morovic, London (GB)

(21) Appl. No.: 17/766,383

(22) PCT Filed: Jan. 30, 2020
(86) PCT No.: PCT/US2020/015874

§ 371 Date: Apr. 4, 2022

(51) Int. Cl. H04N 1/60; G06T 7/90

(52) U.S. Cl. CPC H04N 1/6038; G06T 7/90; H04N 1/6097; G06T 2207/10024

(57) ABSTRACT

In an example, a method includes obtaining, by processing circuitry, a mapping from at least one measured color characteristic of a first substrate to at least one measured color characteristic of a second substrate, wherein the at least one measured color characteristic of the first substrate comprises a measured color characteristic of an unmarked portion of the first substrate and the at least one measured color characteristic of the second substrate comprises a measured color characteristic of an unmarked portion of the second substrate. In some examples the method further includes applying, by processing circuitry, the mapping to a first color which is obtained when applying at least one colorant according to a first colorant specification on the first substrate to determine a predicted color to be obtained by applying at least one colorant according to the first colorant specification on the second substrate.

### BACKGROUND

Color may be applied to different substrates having different properties. The colorimetry of the resulting image may be affected by the particular substrate on which the image is printed. For example, a printing apparatus may be characterised based on printing on a white substrate such that, for example, when a print agent such as cyan ink is printed it may appear cyan in color when applied to the white substrate. However, if the same cyan ink is applied to a yellow substrate, it may produce a greener color due to the interaction between the yellow substrate and the cyan ink. Therefore, the colorimetry of a printed image varies with the properties of the substrate.

### BRIEF DESCRIPTION OF DRAWINGS

Non-limiting examples will now be described with reference to the accompanying drawings, in which:

FIG. 1 is a flowchart of an example method of applying a color mapping;

FIGS. 2A and 2B are graphs showing reflectance of print agents on different substrates;

FIGS. 3-8 are flowcharts of example methods of applying a color mapping;

FIG. 9 is an example of a machine-readable medium in association with a processor; and

FIG. 10 is a simplified schematic of an example of an apparatus for applying a color mapping.

### DETAILED DESCRIPTION

References to ‘printing’ should be understood as being any method of applying colorants and other non-colorant fluids such as fixers or overcoats to substrates. In some examples, a printing apparatus, such as an inkjet printer, a dye-sublimation printer or a liquid electrophotographic (LEP) printer, may be used to print using colorants on a range of different substrates, for example, paper, card, textile, fabric or plastic, and the colorants used may comprise print agents. In some examples, the substrate may be a dye-ground substrate, for example a dye-ground textile or fabric. In some examples printing is a digital process, whereas in other examples printing comprises applying ink to a substrate using any means, for example by using an analogue process such as screen printing or painting, and the colorants may comprise dies or paints. In other examples, the printing apparatus may comprise an additive manufacturing apparatus, in which the substrate may be provided by a layer of build material (for example, granular or powdered plastic) to which a colorant, which may be a printed print agent, may be applied to produce a particular colour for the object being generated. References to ‘substrate’ herein should therefore be understood to include such a layer of build material.

In some examples, the properties of the substrate can affect the quality and colorimetry of colorants applied thereto. For example, the color of the substrate may have a significant impact on the resulting colorimetry.

In order to accurately predict the color that will be achieved when a particular colorant, or combination of colorants, is applied to a particular substrate, one method would be to generate and measure a large number of color samples, or ‘test patches’ on that substrate.

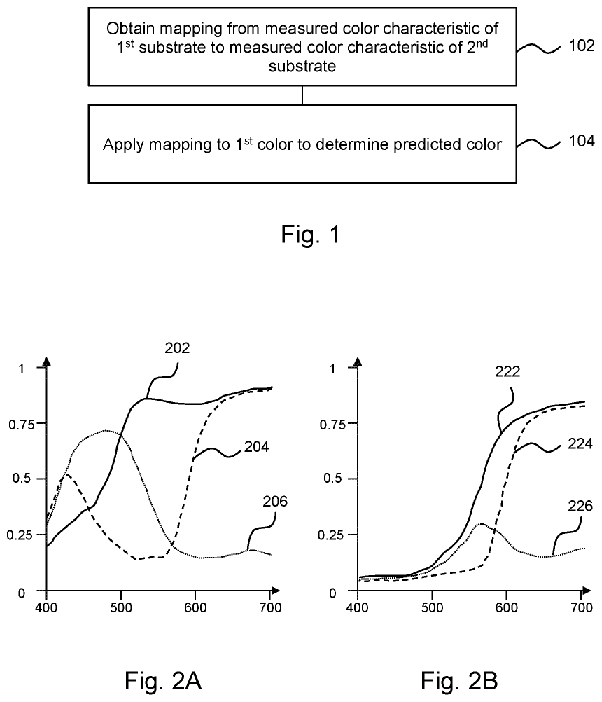

FIG. 1 is an example of a method, which may comprise a computer implemented method and/or a method of color mapping from at least one color which has been applied to and measured from a first substrate to a predicted color which may be observed on another substrate.

Block 102 comprises obtaining, by processing circuitry, a mapping from at least one measured color characteristic of a first substrate to at least one measured color characteristic of a second substrate. The first substrate may be a substrate for which the behaviour of applied colorants is well characterised. The first substrate may comprise a commonly used substrate. For example, the first substrate may be a neutral substrate, for example an uncoloured or white substrate. Such a substrate may also be referred to as a reference substrate. In other examples, both the first substrate and the second substrates are colored substrates of different (non-white, or non-neutral) colors.

The at least one measured color characteristic of the first substrate comprises a measured color characteristic of an unmarked portion of the first substrate and the at least one measured color characteristic of the second substrate comprises a measured color characteristic of an unmarked portion of the second substrate.

The first and second substrates may comprise different color characteristics, for example they may be different colors. The method may comprise measuring the color characteristics or obtaining them by other means. For example, the color characteristics may have been measured previously and may be obtained from a memory, over a network, from a local library comprising information relating to the substrates or the like. In some examples, the first substrate may be a white substrate and the second substrate may be a different color from the first substrate. For example, the second substrate may be a colored substrate such as a blue, brown, cyan, green, magenta, orange or yellow substrate. In other examples both the first and second substrates are colored substrates of different (non-white, or non-neutral) colors. In some examples the second substrate is of the same type as the first substrate, for example the first substrate and the second substrate may comprise substantially the same materials but differ in color. In some examples, instead of or in addition to being different colors, the second substrate may differ in another color characteristic, such as reflectivity (e.g. ‘glossiness’, or ‘mattness’) or texture. However, in other examples, the substrates may share the same reflectivity/texture and/or other characteristics.

Block 104 comprises applying the mapping to a first color which is obtained when applying at least one colorant according to a first colorant specification on the first substrate to determine a predicted color to be obtained by applying at least one colorant according to the first colorant specification on the second substrate.

The colorant specification may specify a distribution of colorants such as print agents. In some examples, the colorant specifications may specify a proportional distribution of colorants such as print agents, for example a volumetric ratio for a set of base colorants. In some examples, the colorant specification may specify a location of colorant distribution (for example specifying a print agent/print agent combination to be applied to a location of the substrate corresponding to each of a plurality of pixels). The locations of the substrate corresponding to pixels are referred to as ‘print addressable locations’ herein.

In some examples, the first colorant specification may specify a proportional area coverage of one or more colorants and/or colorant combinations. For example, in a simple case, a colorant specification may indicate that the particular print material or print material combination should be applied to that location on X % of occasions, whereas (100−X) % of occasions the location should be left clear of the print material. In practice, this may be resolved at the addressable resolution for the print material and/or printing device (for example, using halftoning or the like). Therefore, if there are N addressable locations in an XY plane associated with such a colorant specification, around X % of these N locations may be expected to receive a print material, while around (100−X) % may not be expected to receive print material.

In some examples, the first colorant specification may be a Neugebauer Primary area coverage (NPac), specifying proportional coverages for print materials and print material combinations. For example, in a printing system with two available print agents (for example, inks, coatings or agents), identified as M1 and M2, where each print material may be independently deposited in an addressable area (e.g. voxel or pixel) as a single drop, there may be 2² (i.e. four) probabilities in a given NPac coverage vector: a first probability for M1 without M2; a second probability for M2 without M1; a third probability for an over-deposit (i.e. a combination) of M1 and M2, e.g. M2 deposited over M1 or vice versa; and a fourth probability for an absence of both M1 and M2 (indicated as Z herein). In this example, it is assumed that a drop of print material may be applied or not: i.e. a binary choice may be made and the value for each agent may be either 0 or 1.

In this case, a colorant specification may be: [M1:P1, M2:P2, M1M2:P3, Z:P4] or with example probabilities [M1:0.2, M2:0.2, M1M2:0.5, Z:0.1]—in a set of print addressable locations (e.g. an [x, y] or an [x, y, z] location (which in some examples may be an [x, y] location in a z slice) in additive manufacturing) to which the colorant specification applies, and on average, 20% of locations are to receive M1 without M2, 20% are to receive M2 without M1, 50% are to receive M1 and M2 and 10% are to be left clear (Z). In non-binary systems, there may be more elements defined describing the different amounts of print agent and/or associated combinations of print agents, which may be applied. As each value is a proportion and the set of values represent the available material combinations, the set of probability values in each element set generally sum to 1 or 100%.

Such colorant specifications allow control of the ‘at pixel’ choices of combinations, or of over printing. Other colorant specifications may not control these choices so precisely. For example, a colorant specification may be a print agent vector which may for example specify that X % of a region receives agent M1 and Y % receives agent M2, but the overprinting of agents may not be explicitly defined (although the sum of X and Y may be greater than 100, so overprinting may result). Through use of NPacs, the overprinting may be controlled.

In other examples, the colorant specification may comprise another description of area coverage of colorants on the substrate. The first colorant specification may therefore describe an area coverage prior to halftoning.

In other examples, the first colorant specification may comprise print apparatus control instructions, i.e. a plurality of ‘at pixel’ choices of print agents or combinations of print agents, for example an area coverage after halftoning, in which each print addressable location is associated with a print agent or print agent combination. In other words, in some examples, the first colorant specification may comprise complete instructions for printing a test patch, which could be used directly by a print apparatus.

The predicted color may be an estimation of what color may be produced when the first colorant specification (e.g. the print agent vector, NPac or print apparatus control instructions) is used to cause printing on the second substrate.

The colors described herein may be described in any appropriate color space. An example of such a color space is CIELAB, which describes a color in terms of three values: L* for the lightness, a* from green to red and b* from blue to yellow. Other examples of color spaces include be Hue-Saturation-Value (HSV), Hue-Saturation-Lightness (HSL), Yule-Nielsen-corrected XYZ, XYZ, or the like.

In some examples the measured color characteristic is a measured characteristic of a substrate or a patch or sample of colorant(s) applied to a substrate. The measured color characteristic may be any optically measured characteristic, and may be an appearance characteristic. In some examples the measured color characteristic comprises a measurement of reflectance. In some examples, the illumination during measurement may be controlled, and many be consistent between different measurements. For example, the substrate may be illuminated, for example by a light source such as an LED, an array of LEDs or a bulb. The substrate may be illuminated by visible radiation, for example by a light source that produces a range of wavelengths of visible radiation, such as white light. The light source may provide radiation of wavelengths across the whole of the visible spectrum, for example the CIE standard illuminant D65. Such a light source may in practice be a tungsten halogen lamp, which provides a relatively smooth distribution of wavelengths with few peaks and has a long life. During the measurement the substrate may be shielded from other light sources in order to provide a more accurate measurement. The light reflected from the substrate may then be measured by a light sensor, such as a photodiode, photoreceptor, charge-coupled device (CCD) or complementary metal-oxide-semiconductor (CMOS) detector or the like. In order to measure a specific wavelength a sensor which is sensitive to a specific wavelength (or narrow range of wavelengths) may be used, or filters may be positioned between the substrate being measured and the light source or light sensor. In some examples, a diffraction grating may be used to separate an optical signal into different wavebands/wavelengths. For example, the diffraction grating may be placed between the substrate being measured and a sensor, which is located to measure intensity of light at a particular wavelength. The sensor and/or the diffraction grating may then be moved to allow the sensor to measure different wavelengths of light. In other examples the sensor may comprise an array of detectors, each arranged to detect light at a different wavelength. In other examples, for example when the sensor is a spectrophotometer, an array of narrow band light sources may be used to isolate different wavelengths. For example, an array of narrow band LEDs may be used with a photoreceptor to measure different wavelengths.

In some examples the measurement of reflectance is a measurement of reflectance as a function of wavelength. Reflectance is a measurement of the fraction of incident radiation power which is reflected from a surface at a particular wavelength. The reflectance may be measured at a plurality of different wavelengths. The light sensor used may be sensitive to light of different wavelengths and may be capable of recording the intensity of light reflected at a plurality of wavelengths. In other examples the light sensor may be sensitive to light of different wavelengths but cannot distinguish between light of different wavelengths (for example a photodiode). Such a light sensor may be used with a range of filters, which may be located between the substrate and the light sensor to measure the intensity of reflected light at different wavelengths.

The methods described herein may in some examples provide a balance between accuracy of a color mapping for a colored substrate and the difficulty in obtaining measurements used in creating the color mapping by using measurements of the color characteristics of the unmarked, e.g. unprinted or blank, substrates.

In some examples, the colors produced by applying colorants to a white/neutral substrate may be well characterised and therefore a color may be reproduced accurately on that substrate by a printing apparatus or the like. However, a user may wish to apply colorant to substrates of different colors, for example a clothing manufacturer may print on fabrics of many different colors. Such a user may wish to characterise each different substrate without first generating, then measuring a large number of test samples on the different substrate(s), while still accurately predicting a colorimetry of images on the different substrate(s). As is set out in greater detail below, by using the color characteristics of the unmarked, or blank substrates, a mapping from a color produced on the first substrate to a predicted color produced using the same colorant specifications on a second substrate may be determined.

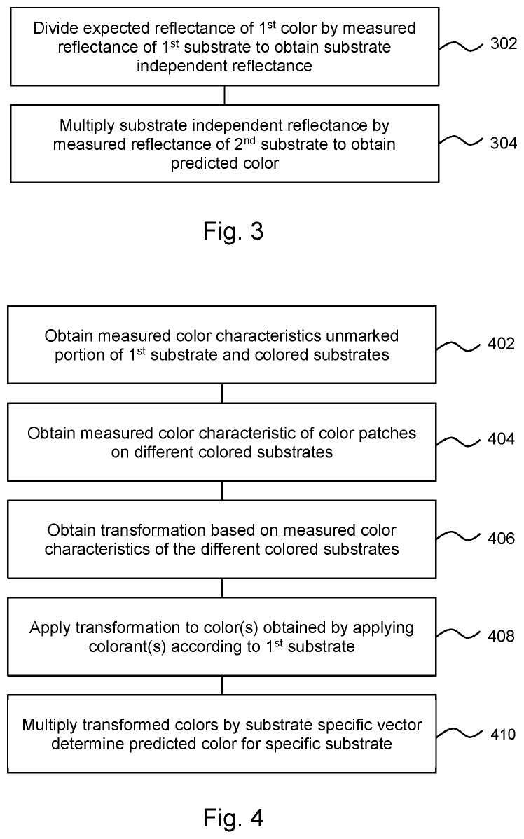

FIGS. 2A and 2B show graphs of examples of reflectance. The horizontal axis is wavelength measured in nanometres (nm) and the vertical axis is reflectance, as a fraction of the incident power which is reflected. FIG. 2A shows the measured reflectance for three printed patches of color (in this example, printed print agents) on a white substrate. The solid line 202 corresponds to a yellow patch of print agent, the long-dashed line 204 corresponds to a magenta patch of print agent and the short-dashed line 206 corresponds to a cyan patch of print agent. As can be seen from the line representing yellow print agent 202, this patch has a low reflectance at shorter wavelengths and higher reflectance at higher wavelengths. In contrast, as can be seen from the line representing cyan print agent 206, the cyan patch has a high reflectance at short wavelengths and a low reflectance at high wavelengths. The magenta print agent has peaks in reflectance at both short and long wavelengths, but low reflectance at intermediate wavelengths.

FIG. 2B represents the reflectance of the same patches of colored print agent but applied to a colored substrate, in this example an orange substrate. In this example the solid line 222 corresponds to a patch of yellow print agent, the long-dashed line 224 corresponds to magenta print agent and the short-dashed line 226 corresponds to cyan print agent. Due to the print agents being applied to the orange substrate the reflectance at shorter wavelengths, in particular for wavelengths below 550 nm, is reduced for each patch of print agent. The line representing reflectance of yellow print agent 222 is relatively unaffected compared with the lines representing reflectance of cyan and magenta 224, 226. The line representing the reflectance of magenta 224 has the peak at shorter wavelengths suppressed, however the peak at longer wavelengths is relatively unaffected, so magenta print agent applied to an orange substrate in this example has a reddish color. The line representing reflectance of cyan 226 shows cyan print agent applied to the example orange substrate has a relatively low reflectance across all wavelengths so will appear dark.

As can be seen from the graphs in FIGS. 2A and 2B, the same colorants can result in very different reflectance and therefore perceived colors depending on the substrate on which they are printed. Furthermore, different colors of colorant are affected to different extents. In this example, yellow print agent is relatively unaffected whereas magenta and cyan print agents will appear significantly different when applied to an orange substrate relative to when applied to a white substrate. Therefore, if an image is applied to a colored substrate by a printing apparatus which is calibrated to print on a white substrate, the colors of the resulting image may appear significantly different to those intended.

In order to determine how a color will appear when applied to a particular substrate, a mapping may be determined which maps from a measured color on a first substrate to a predicted color describing how it may appear when applied to that substrate. The accuracy of the determined mapping may depend on a number of factors, for example the number and type of measurements which are used to generate the mapping. Therefore, there may be a balance between the accuracy of the mapping and the number of measurements used to generate the mapping, as can be seen for the examples which follow.

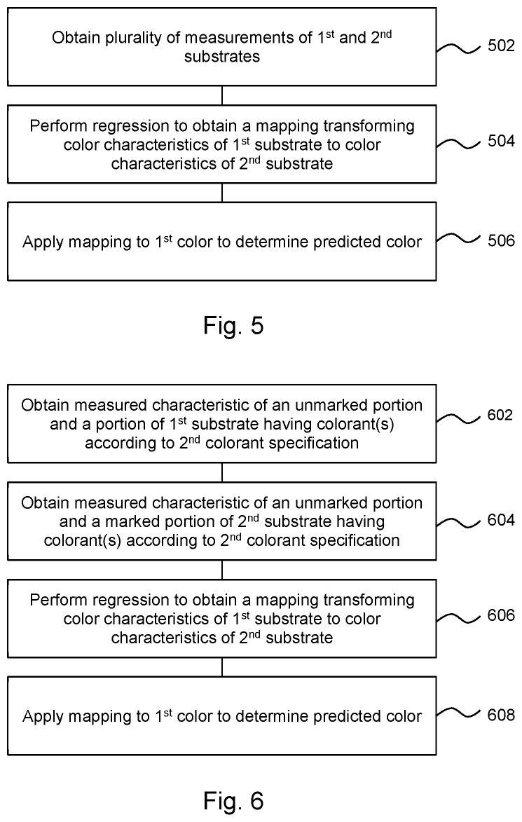

FIG. 3 is an example of a method, which may be a computer implemented method of obtaining and applying a mapping, for example the method described in relation to FIG. 1. This method may be referred to as a “substrate-independent mapping”.

In this method, the mapping discussed in relation to block 102 of FIG. 1 comprises a ratio between the reflectance of the unmarked portion of the second substrate and the reflectance of the unmarked (i.e. unmarked by colorant(s)) portion of the first substrate, and blocks 302 and 304 set out a method of applying the mapping. In other words, blocks 302 and 304 provide an example method of carrying out block 104. Block 302 comprises, for a plurality of wavelengths, dividing an expected reflectance of the first color by the measured reflectance of the first substrate at that wavelength to obtain a substrate independent reflectance. In some examples the expected reflectance of the first color is obtained by measuring the reflectance of the first color when generated according to the first colorant specification on the first substrate.

In a particular example, the measured reflectance of a blank/unmarked portion of the first substrate and at least one portion of the first substrate having colorant(s) applied thereto (for example, a test patch printed according to a first colorant specification or another colorant specification) may be denoted by a matrix N. The first substrate may be a white or uncolored substrate and may be well characterised, in that many measurements may be made of the first substrate with a large number of test samples and saved for later use. For example, such a set of measurements may be performed at manufacture or characterisation of a printing apparatus and may be stored in a memory of the printing apparatus for later use. In other examples, the printing apparatus may be able to access measurements from a storage device or over a network.

Each element of the matrix N may be a measurement of a reflectance for a sample (i.e. the unmarked first substrate and at least one colored test patch) at a different wavelength. For example, the matrix N may comprise reflectance measurements of a plurality of different colors of patches on the first substrate. For example, each row of the matrix N may relate to a sample and each column may relate to a wavelength. In some examples, the first row of the matrix N comprises the measurements of the blank/unmarked portion of the first substrate and further rows of the matrix N may comprise measurements of colored, e.g. printed samples, each sample corresponding to a different colorant specification, applied to the first substrate. The measurements may be single measurements or may comprise an average of multiple measurements.

In such an example, block 302 may comprise dividing each element of the matrix N by the reflectance of the unmarked portion of the first substrate at the corresponding wavelength. In the example where the first row of the matrix N comprises measurements of the unmarked portion, this comprises dividing each element of a column of N by the element in the first row of that column. This may be expressed as M=N·1/N(1), wherein M is a set of reflectances, which have the contribution from the first substrate conceptually removed. The matrix M may be referred to as a substrate-independent matrix, as it has conceptually ‘removed’ or cancelled out the color contribution of the first substrate to the colored (e.g. printed) sample.

Block 304 completes the application of the mapping multiplying the substrate independent reflectance for each of plurality of wavelengths, by the measured reflectance of the second substrate at that wavelength to obtain the predicted color.

The measured reflectance of the second substrate may be expressed as a vector b. Each element of the vector b may comprise a measured value of the reflectance at a different wavelength. The mapping may be obtained by multiplying the vector b by the matrix M to obtain a matrix B, wherein the matrix B comprises the predicted colors obtained when the colors of N are applied to a different colored substrate. This operation may be expressed as B=M·b and comprises multiplying the elements of b by the corresponding elements of M, wherein corresponding elements are those of the same wavelength. When multiplying by b a dot-product is performed so every element of the matrix is multiplied, row by row, with the same element by element contents. All the matrices N, M, B in this example comprise the same number of rows and columns i.e. they describe same number of color patches and the same number of spectral samples.

The mapping may be characterised as: [1/N(1)]·b which is applied to the matrix N to obtain a prediction of the colors in matrix N when applied to second substrate.

This can be seen as conceptually ‘adding’ the color contribution of the second substrate. The method may comprise using a single measurement of the second substrate (or a small number of measurements to provide an average), and therefore may be relatively quick and easy to perform. Furthermore, the measurement of the second substrate is of an unmarked portion of the second substrate, and therefore there is no need to apply colorants to the second substrate to perform the method. This may conserve resources and time.

Table 1 shows how the above described mapping performs relative to other methods. The numerical values of the “No mapping” column of Table 1 are DE2000 color differences between color patches applied to a blue dye-ground textile substrate compared with the same color patches applied to an uncolored textile substrate, which in this example is similar to the blue substrate in terms of weave, density and colorant absorption, but lacks the colorant. For example, the uncolored textile substrate may be the same textile as the dye-ground textile substrate, prior to dying being performed. The uncolored substrate may also be described as a ‘neutral’, ‘achromatic’ or ‘base’ substrate. In some examples the uncolored substrate appears white or pale yellow in color. In some examples the uncolored substrate is treated, for example by bleaching or with a white colorant to achieve the uncolored state, or it may be untreated and have the color of the material in its natural state.

The DE2000 color differences describe the difference between a color applied to the uncolored substrate and the blue substrate. For example, a value of 33 DE means that 33 visually distinct color samples can be placed between the two colors.

The ‘No Mapping’ numerical values show the color differences when the same colorant specification is used for printing on the uncoloured and the colored substrates. This shows that the effect of the color of the substrate can be large, with an average difference of 33 DE. The numerical values of the “Full Mapping” and “Media Independent Mapping” are also DE2000 color differences, however these show differences achieved when a mapping is used to improve the correspondence between the colors achieved when printing on the colored substrate compared with the uncolored substrate. The “Full Mapping” is a mapping based on a training set where a full color chart is applied to each of the two substrates and each color of the color chart is measured, for example a color profiling target comprising 854 samples. In this example, a colorant specification to generate each target color has effectively been generated separately for each substrate. The target color samples can be accurately produced on both samples (as can be seen in Table 1, 95% below 1 DE2000 means that 95% of the colors can be matched to a degree where they are indistinguishable when viewed side by side with a gap between the substrates), however it may be time consuming and difficult to implement in practice. The “Full Mapping” column shows how the DE2000 color differences are reduced compared with the “No Mapping” column when a full characterisation of colorant specifications is carried out separately for each substrate. This uses many measurements of colored print agent patches on both the first and second substrates and therefore is relatively time consuming, however it may result in small color differences.

The “Substrate-Independent Mapping” shows the DE2000 color differences (minimum, median, mean, standards deviation, 95^{th} percentile and maximum), for the same two substrates, which may be achieved when using the above mapping described in FIG. 3. In this case, different colorant specifications are used for the different substrates, having been derived based on the color differences predicted by the mappings. For example, a colorant specification for an intended color may be determined by interpolating between two or more specification which are predicted to result in a color which is close to the intended color. In other words, the color difference is the difference between colors printed on a neutral substrate, and colors which are printed using colorant specifications derived based on the mappings set out above (for example, based on interpolation of colorant specifications to which a mapping has been applied) which are expected to be the same as the colors which were printed on the neutral substrate. Lower numbers are indicative of closer color matches, and therefore indicative of a better result. This is also the case for the third column of the tables set out below. The differences are considerably lower than those achieved when no mapping is used, however are not as low as those achieved by a full mapping. However, the Substrate-Independent Mapping method does not use a full characterisation as used by the Full Mapping and therefore may be applied much more quickly and easily by a user. In particular this method does not use any measurements performed on printed color patches on the second substrate.

TABLE 1

| | | | Substrate-Independent |
|---|---|---|---|
| | No Mapping | Full Mapping | Mapping |
| Min | 4.0705 | 0.0200 | 0 |
| Median | 34.5403 | 0.3565 | 9.8876 |
| Mean | 33.8627 | 0.4066 | 9.4068 |
| Std | 12.1347 | 0.2620 | 2.9261 |
| Percentile 95 | 51.9393 | 0.8677 | 13.5756 |
| Max | 57.4937 | 2.3907 | 20.0647 |

The method may perform better for some classes of substrate than for others. For example, if the first and second substrate are similar in most regards except color (for example, they are spectrally similar, in some examples comprising at least one of the same type of material, coating, printing fluid absorption characteristics and the like), then the method may perform better than if the first and second substrate are dissimilar.

FIG. 4 is an example of a method, which may be an example of the method of applying a mapping described in FIG. 1. In this example, the color contribution of a number of different substrates is, in effect, generalised and the mapping comprises a transformation function.

Block 402 comprises obtaining a measured color characteristic of the (blank or unmarked) first substrate and a measured color characteristic of an unmarked portion of each of a plurality of different colored substrates. The measured color characteristic may be reflectance, for example as described in relation to FIGS. 2A and 2B. The plurality of different colored substrates may be selected to include a variety of colors. In particular the plurality of different colored substrates may be selected to provide a representative sample of colors of substrates. The plurality of different colored substrates may all be the same type of substrate, for example they may all comprise the same material e.g. they may be the same type of paper or textile and/or may share other characteristics as outlined above.

In this example, block 404 comprises obtaining color characteristics of a plurality of printed patches printed on a plurality of substrates. The measured color characteristics may be obtained by performing measurements of the plurality of substrates or by obtaining data representing such measurements for example from a memory, over a network or the like. The number of measurements or samples used may vary depending on what data is available. For example a color profiling target comprising 854 samples may be used, which is the same as in the “Full Mapping” example, but the method differs in that a generic mapping is created for all colored substrates rather than a specific mapping between two known substrates e.g. uncolored to blue. The generic mapping represents the general changes between the reference substrate and any other substrate, and therefore reduces the error in mapping between the reference substrate and colored substrates.

In an example the measured color characteristics of the plurality of different colored substrates are represented by a plurality of matrices Ni, where i is an index unique to each substrate type, for example N1 may correspond to an uncolored (e.g. white) substrate. A plurality of printed patches of different colors may be applied to each color substrate, for example using the same set of colorant specifications to print on each color substrate, and the corresponding matrix Ni may comprise measured color characteristics of each colored patch on that substrate, for example as described in relation to the matrix N described in relation to block 302 of FIG. 3.

For each matrix Ni, a matrix Mi may be obtained by dividing each element of the matrix Ni by the reflectance of the unmarked portion of that substrate at the corresponding wavelength. In an example the first row of the matrix Ni comprises measurements of the unmarked portion, and therefore this comprises dividing each element of a column of Ni by the element in the first row of that column. This may be expressed as Mi=Ni·1/Ni(1). In practice the matrix corresponding to an uncolored substrate (in this example, N1) may be larger than the matrices for other colors of substrate.

The resulting set of matrices Mi each represent a different set of measurements from which the color contribution of the underlying substrate has been removed. In an idealised situation, assuming the same set of colorant specifications is used to print on each substrate, it may therefore be expected that each of the matrices would be the same, but this is not seen in practice. In fact, different interactions between the substrates and the print agents occur, and therefore, even in that situation, differences are likely to exist between the matrices. In some examples, the measurements performed on each substrate may comprise measuring samples applied to each substrate using the same colorant specifications. This may characterise the ink-media interaction and its impact on the final color.

Block 406 comprises obtaining a transformation based on a combination of measured color characteristics of the plurality of different colored substrates. This can be thought of as a common contribution, or an ‘average’, of the differences between the color contributions of color substrates and therefore provides in effect a correction for the difference between printing on the first substrate and a generalised ‘other’ substrate. In an example, obtaining the transformation comprises determining a media-common mapping which accounts for the common contributions to the color obtained when print agent is applied to any colored substrate of a particular type.

The transformation may be a matrix T, and may, in this example, be obtained by minimising ∥f([M2, M3, . . . , Mn])*T−[M1, M1, . . . , M1]∥ wherein f( ) is a function which transforms the measured characteristics Mi.

To explain this in a little more detail, in the function to be minimised, ∥⋅∥ indicates the L2 norm. The function f( ) is a function which expresses the matrices M2, M3, . . . Mn in polynomial form, for example in each matrix Mi each row may represent each printed color patch and each column may represent a spectral sample i.e. a measurement at a particular wavelength. The polynomial function f( ) may be a matrix of the same number of rows, but may comprise a different number of columns. For example the polynomial function f( ) may comprise additional columns. The additional columns may comprise additional terms obtained by cross-combining, or multiplying, some of the columns. For example, a matrix may comprise 854 rows and 31 columns, wherein the 31 columns correspond to 31 spectral samples. Where the polynomial function f( ) comprises second order terms, such as squared terms, the matrix comprises 854 rows and 62 columns i.e. the same number of rows, but twice as many columns. The function f( ) may perform any operation on the columns or add terms (e.g. adding constants). The notation [M2, M3, . . . , Mn] indicates a matrix comprising all matrices M2, M3, . . . , Mn, which in this example are stacked vertically, such that if there are (n−1) different colored substrates and P patches of color on each, then the combined matrix would comprise (n−1)P rows. Similarly [M1, M1, . . . , M1] is a matrix comprising (n−1) M1 matrices stacked vertically. The matrix T is then the matrix that best maps M2, M3, . . . , Mn to M1 over all the colored substrates.

Block 408 comprises applying the transformation to the color obtained by applying print agent according to the first colorant specification on the first substrate. The transformation T may be applied to the matrix M1 by multiplying the matrix M1 by T to obtain a substrate independent matrix O1, which can be written as O1=M1*T.

Block 410 comprises multiplying the substrate independent matrix O1 by a vector specific to a colored substrate to obtain a predicted color for that substrate. In this example, the vector is vector bi comprising elements describing the reflectance of the second substrate at a plurality of wavelengths to obtain the predicted color when applied to the second substrate, Bi=O1*bi.

Thus, in this example, applying the mapping may comprise removing the color contribution of the first substrate (determine M1 from N1), applying the ‘correction’ T derived from the set of colored substrates to determine O1, then ‘adding’ the color contribution of the second substrate.

The mapping in this example, may be characterised as: [1/N1(1)]*T*bi which is applied to the matrix N1 to obtain a prediction of the colors in matrix N1 when applied to second substrate i.

The method described in FIG. 4 may be referred to as a media-independent mapping with a media-common correction characterised by T. Table 2 is a table showing DE2000 color differences obtained when printing on the blue substrate described previously in relation to Table 1. The “No Mapping” and “Full Mapping” columns are identical to those in Table 1. The “Media Independent Mapping+Media Common Correction” column shows DE2000 color differences for an example of the method described in FIG. 4. As can be seen the media-independent mapping with media-common correction performs significantly better than no mapping but is not as accurate as a full mapping. However, the media independent mapping with media common correction method can be performed with significantly fewer measurements compared with a full mapping method.

TABLE 2

| | | | Media Independent |
|---|---|---|---|
| | | Full | Mapping + Media |
| | No Mapping | Mapping | Common Correction |
| Min | 4.0705 | 0.0200 | 1.1153 |
| Median | 34.5403 | 0.3565 | 6.5039 |
| Mean | 33.8627 | 0.4066 | 7.0868 |
| Std | 12.1347 | 0.2620 | 3.6474 |
| Percentile 95 | 51.9393 | 0.8677 | 13.3688 |
| Max | 57.4937 | 2.3907 | 16.9840 |

FIG. 5 is an example of a method, which may be a method of applying a color mapping.

Block 502 comprises obtaining a plurality of measurements of the first and second substrate. The plurality of measurements may be measurements of reflectance at a plurality of wavelengths for each of the first and second substrates. In some examples, while this includes measurements of unmarked portions of each of the substrates, and measurements taken from at least one printed sample on the first substrate, no measurements may be taken of printed portions of the second substrate. Therefore, this method may be relatively quick and easy to apply.

Block 504 comprises performing a regression to obtain a mapping which transforms the measured color characteristics of the first substrate to the measured color characteristics of the second substrate. A regression may be performed to determine a vector X which satisfies Mn(1)=X·M1(1), wherein Mn(1) is a measurement of the reflectance of an unmarked portion of the second (colored) substrate at a plurality of wavelengths and M1(1) is a measurement of reflectance of an unmarked portion of the first substrate at the plurality of wavelengths.

In one example the regression is a second order polynomial regression. In another example the regression is a least squares method. In the above example least squares is used to minimise ∥f(Mn(1))*X−M1(1)∥ where Mn(1) is an input (e.g. the colored substrate reflectance) and M1(1) an output (e.g. the uncolored or neutral substrate reflectance) and function f( ) some transformation. If function f( ) is an identity then the regression is a linear regression, whereas if f( ) has higher order or cross terms, the regression is a non-linear regression. In other examples, any suitable form of regression or curve fitting could be used, for example Machine Learning, such as Supervised Learning may be used.

Therefore, in this example, the mapping is described by X, and this may be applied to each color to determine a predicted color.

Block 506 comprises applying the mapping to a first color which is obtained when applying print agent according to a first colorant specification on the first substrate to determine a predicted color to be obtained by applying print agent according to the first colorant specification on the second substrate. Applying the mapping may comprise multiplying a vector representing the first color obtained by applying print agent according to the first colorant specification on the first substrate with the vector X to determine the predicted color obtained by applying print agent according to the first colorant specification on the second substrate. For example, a vector Bi representing the predicted color may be obtained as Bi=X·N1(i), wherein N1(i) is the first color obtained by applying print agent according to the first colorant specification on the first substrate.

The method described in FIG. 5 may be referred to as a media based regression mapping. Table 3 is a table showing DE2000 color differences obtained when printing on the blue substrate described previously in relation to Tables 1-2. The “No Mapping” and “Full Mapping” are identical to those in Tables 1-2. The “Media Based Least Squares” column shows DE2000 color differences for an example of the method described in FIG. 5, wherein a least squares regression is used. As can be seen the media based least squares mapping performs significantly better than no mapping but is not as accurate as a full mapping. However, the media based least squares method can be performed with significantly fewer measurements compared with a full mapping method, and without measurements of printed patches of print agent on the second substrate. Indeed, it may be noted that, in this example, the method performs worse than the method described in relation to FIG. 3. However, as can be seen from the methods described below, it provides the basis for better performing techniques, and may perform better in other examples. A least squares regression minimises the L2 norm and therefore minimises the distance from the measured data to the predicted data, and therefore provides good results. A solution to the regression may be obtained via the Moore-Penrose inverse or pseudo-inverse as well as variants that impose constraints on the robustness of the solution by means of regularization terms (e.g. Tikhonov regularization) as well as robust inverse computations (e.g. using Singular Value Decomposition). In practice these more robust methods may impact numerical performance but do avoid rank-deficiency of the matrix and prevent the solution being fragile. Use of least squares provides good results even when there is an outlier, or a small number of outliers, since the fit is weighted by the frequency of the data i.e. a single outlier provides only a small contribution to the overall fit.

TABLE 3

| | | Full | Media Based Least |
|---|---|---|---|
| | No Mapping | Mapping | Squares |
| Min | 4.0705 | 0.0200 | 0 |
| Median | 34.5403 | 0.3565 | 11.5408 |
| Mean | 33.8627 | 0.4066 | 11.0937 |
| Std | 12.1347 | 0.2620 | 4.1364 |
| Percentile 95 | 51.9393 | 0.8677 | 17.8114 |
| Max | 57.4937 | 2.3907 | 22.9673 |

FIG. 6 is an example of a method, which may be a method of applying a color mapping. The method of FIG. 6 is similar to that of FIG. 5 but uses additional measurements to increase the accuracy of the mapping.

Block 602 comprises obtaining a plurality of measured color characteristics of a first substrate, wherein the measured color characteristics of the first substrate comprise a measured characteristic of a printed portion of the first substrate printed according to a second colorant specification and a measured color characteristic of an unmarked portion of the first substrate.

Block 604 comprises obtaining a plurality of measured color characteristics of a second substrate, wherein the measured color characteristics of the second substrate comprise a measured characteristic of a printed portion of the second substrate printed according to the second colorant specification and a measured color characteristic of an unmarked portion of the second substrate. Therefore, the method comprises obtaining measured color characteristics of printed portions of the substrates, in comparison to the method of FIG. 5 in which measurements are used of the unmarked portions. While in this example measurements of a single printed sample are generated from two colorant specifications, in other examples, more samples may be printed

Block 606 comprises obtaining the mapping by performing a regression to obtain the mapping which transforms the measured color characteristics of the first substrate to the measured color characteristics of the second substrate, for example in a similar manner to as described in block 504 of FIG. 5. A regression may be performed to determine a vector Y which satisfies Mn=Y·M1, wherein Mn comprises measurements of the reflectance of printed and unmarked portions of the second (colored) substrate at a plurality of wavelengths and M1 comprises measurements of reflectance of printed and unmarked portions of the first substrate at the plurality of wavelengths.

In one example the regression is a second order polynomial regression. In another example the regression is a least squares method.

Block 608 comprises applying the mapping Y to a first color obtained by applying print agent according to a first colorant specification on the first substrate to determine a predicted color to be obtained by applying print agent according to the first colorant specification on the second substrate, for example as described in block 506 of FIG. 5. In practice, the mapping Y may be applied to each of a plurality of colors obtained by applying print agent according to each of a plurality of colorant specifications on the first substrate to determine a predicted color to be obtained by applying print agent according to the same colorant specification on the second substrate

Applying the mapping may comprise multiplying the vector Y with a vector representing the first color obtained by applying print agent according to the first colorant specification on the first substrate to determine the predicted color obtained by applying print agent according to the first colorant specification on the second substrate. For example, a vector Bi representing the predicted color may be obtained as Bi=Y·N1(i), wherein N1(i) is the first color obtained by applying print agent according to the first colorant specification on the first substrate.

In some examples the second colorant specification instructs printing of a colored patch comprising a single color of print agent. The second colorant specification may comprise instructions that cause a printing apparatus to print a colored patch, or colored patches, of print agent on a substrate. For example in a printing apparatus which uses cyan, magenta, yellow and black (CMYK) print agents, generating the mapping may be based on measurements of samples printed using a second, third, fourth and fifth colorant specification which may comprise an instruction to print a patch of cyan print agent, a patch of magenta print agent, a patch of yellow print agent and/or a patch of black print agent. Where other print agent color sets are used, the number of printed samples may be the same as the number of print agents such that each color is applied to each substrate. In some examples, the same coverage of print agent may be applied to each sample, which may be the maximum coverage of a particular print apparatus. Therefore, in some examples, the set of printed samples may comprise the ‘primary’ colors of a print agent set of a print apparatus.

The method described in FIG. 6 with measurements of CMYK color patches may be referred to as a media and CMYK regression mapping. In an example where a least squares regression is used the mapping may be referred to as a media and CMYK least square mapping. Table 4 is a table showing DE2000 color differences obtained when printing on the blue substrate described previously in relation to Tables 1-3. The “No Mapping” and “Full Mapping” columns are identical to those in Tables 1-3. The “Media+CMYK Least Squares” column shows DE2000 color differences for an example of the method described in FIG. 6, wherein a least squares regression is used. The media and CMYK mapping performs significantly better than the media based mapping shown in Table 3 (as can be seen from the lower numbers), however in order to generate the media and CMYK mapping, additional measurements are used which involve printing and measuring on the second substrate. Therefore, this method is more complex to implement, however results in a more accurate mapping.

TABLE 4

| | | Full | Media + CMYK Least |
|---|---|---|---|
| | No Mapping | Mapping | Squares |
| Min | 4.0705 | 0.0200 | 0 |
| Median | 34.5403 | 0.3565 | 3.3757 |
| Mean | 33.8627 | 0.4066 | 3.4777 |
| Std | 12.1347 | 0.2620 | 1.7026 |
| Percentile 95 | 51.9393 | 0.8677 | 6.4102 |
| Max | 57.4937 | 2.3907 | 13.0477 |

FIG. 7 is an example of a method, which may be a method of applying a color mapping. The blocks of FIG. 7 generally correspond to the blocks of FIG. 6, however the method of FIG. 7 makes use of additional measured characteristics.

Block 702 comprises obtaining measured characteristics as described in block 602 of FIG. 6, and additionally the measured color characteristics of the first substrate comprise a measured characteristic of a printed portion of the first substrate printed according to a third colorant specification.

Block 704 comprises obtaining measured characteristics as described in block 604 of FIG. 6, and additionally the measured color characteristics of the second substrate comprise a measured characteristic of a printed portion of the second substrate printed according to the third colorant specification. Therefore, the method comprises using a measured characteristic of at least two colored printed portions of each of the first and second substrates.

In this example, the second colorant specification instructs printing of a patch using a single color of print agent and the third colorant specification instructs printing of a patch using a plurality of colors of print agent. The third colorant specification may instruct printing of a patch of print agent comprising two colors of print agent, the color being a ‘secondary’ color of the print agent set. For example, for a CMYK color set, the third colorant specification may instruct the printing of red (using a combination of magenta and yellow print agent), green (using a combination of yellow and cyan print agent) or blue (using a combination of cyan and magenta print agent). In other examples the third colorant specification may comprise instructions to print any color of print agent using any combination of print agents available in the printing apparatus.

In an example a set of colorant specifications comprises instructions to instruct the print apparatus to print a patch of color corresponding to each print agent available in the printer, for example in a CMYK printer, to print four patches of print agent: cyan, yellow, magenta and black (the primary colors). In this example, a further set of colorant specifications comprises instructions to print patches of color, each patch comprising more than one print agent, for example a red patch, a blue patch and a green patch (the secondary colors). Therefore, in this example seven patches of print agent may be printed: cyan, magenta, yellow, black, red, green and blue. In this example, it may be noted that the combinations do not include combinations with the black ink. Combining a non-black ink with a black ink would increase the number of color patches to be printed and may not significantly contribute to the robustness of the method. This may be because combining a non-black ink with a black ink results in a darker (near-black) version of the color of the non-black ink i.e. a change in lightness but not hue. Measurements of each patch may be obtained for each patch for both the first and second substrates. Additionally, measurements are obtained of an unmarked portion of each of the first and second substrates. The additional information acquired from the additional patches of print agent may allow a more accurate mapping to be determined, as shown below in Table 5.

Analogously to the method described in FIG. 6, a vector Z may be obtained by performing a regression for the vector Z which satisfies Mn=Z*M1, wherein Mn comprises measurements of the reflectance of printed and unmarked portions of the second (colored) substrate at a plurality of wavelengths and M1 comprises measurements of reflectance of printed and unmarked portions of the first substrate at the plurality of wavelengths. The printed portions correspond to patches of print agent printed according to both the second and third colorant specifications. Applying the mapping may comprise multiplying the vector Z with a vector representing the first color obtained by applying print agent according to the first colorant specification on the first substrate to determine the predicted color obtained by applying print agent according to the first colorant specification on the second substrate. For example, a vector Bi representing the predicted color may be obtained as Bi=Z*N1(i), wherein N1(i) is the first color obtained by applying print agent according to the first colorant specification on the first substrate.

The method described in FIG. 7 with measurements of cyan, magenta, yellow and black (CMYK) and red, green and blue (RGB) color patches may be referred to as a media and CMYK RGB regression mapping. In a CMYK printing apparatus, the red, green and blue color patches may be printed by printing a patch using a combination of yellow and magenta ink to obtain the red patch, a patch using a combination of yellow and cyan ink to obtain the green patch and a patch using a combination of cyan and magenta to obtain the blue patch. In an example where a least squares regression is used the mapping may be referred to as a media and CMYK RGB least square mapping. Table 5 is a table showing DE2000 color differences obtained when printing on the blue substrate described previously in relation to Tables 1-4. The “No Mapping” and “Full Mapping” are identical to those in Tables 1-4. The “Media+CMYK RGB Least Squares” column shows DE2000 color differences for an example based on the method described in FIG. 7, wherein a least squares regression is used. The media and CMYK RGB mapping performs significantly better than the media and CMYK mapping shown in Table 4, however in order to generate the media and CMYK RGB mapping, additional measurements are used which involve printing and measuring on the second substrate. Therefore, this method is more complex to implement, however results in a more accurate mapping.

TABLE 5

| | | Full | Media + CMYK RGB Least |
|---|---|---|---|
| | No Mapping | Mapping | Squares |
| Min | 4.0705 | 0.0200 | 0 |
| Median | 34.5403 | 0.3565 | 1.5480 |
| Mean | 33.8627 | 0.4066 | 1.8566 |
| Std | 12.1347 | 0.2620 | 1.2082 |
| Percentile 95 | 51.9393 | 0.8677 | 3.9444 |
| Max | 57.4937 | 2.3907 | 7.5872 |

In some examples the methods described above further comprise applying print agent according to the first colorant specification on the second substrate, measuring at least one color characteristic of the printed output, and determining a color mapping resource for printing on the second substrate based on the measured color characteristic and the first colorant specification.

In some examples determining the color mapping resource comprises generating a look-up table for use in transforming images for printing on a colored substrate. This may for example precompute the mappings so that they do not have to be derived ‘on the fly’. The look-up table may associate a colorant specification with a predicted color on a particular substrate. In some examples a separate look-up table is generated for each color of substrate the colorant may be applied to. If a color which is intermediate to one in the mapping resource is to be printed, the colorant specifications may be determined by interpolating colorant specifications relating to colors which are similar to the intended color.

To discuss the determination of a color mapping resource in a more detail, in an example, a first colorant specification may be used to print a light blue on an uncolored substrate, a second colorant specification may be used to print a medium blue on the same uncolored substrate and a third colorant specification may be used to print a dark blue on the same uncolored substrate. These mappings between colors and colorant specifications (along with others) may be stored in a color mapping resource for the uncoloured substrate.

While in some examples, the color mapping resource for a given colored substrate may include the same colorant specifications associated with their predicted color, in other examples the same set of colors may be included. In such examples, determining a color mapping resource comprise determining as set of colorant specifications for printing colorants on a colored substrate such that the printed colorants result in colors which appear the same as those printed on the uncolored substrate. For example, the color mapping resource may include (among others) a fourth, fifth and sixth colorant specification which when used to print on the colored substrate results in colors that appear the same as the light, medium and dark blue colors.

As set out above, a mapping may be determined which predicts the result of printing the first, second and third print instruction on the colored substrate. For the sake of example, in once case the ‘medium blue’ color is chromatically between the predicted results for the first, second and third print instruction, and therefore an the fifth colorant specification may be interpolated for printing the medium blue color on the colored substrate by interpolating from the first, second and third (and in some examples, at least one other) colorant specification. The other colorant specifications for printing a predetermined color set may be generated in a similar way.

In some examples the method described above further comprises applying the determined color mapping resource for printing on the second substrate to an image to be printed to map said image to colorant specifications. The method may further comprise printing said image. When the image is applied to the second substrate, the colorimetry of the printed image may be more accurate than if the mapping resource for the first substrate was used.

FIG. 8 is an example of a method, which may comprise a computer implemented method of predicting a color obtained by printing on a colored substrate.

Block 802 comprises obtaining a first measurement characterising a color value of an unmarked portion of a reference substrate. In some examples the measurement is a measurement of reflectance and may be a measurement of reflectance at multiple different wavelengths. In other examples the measurement may be a measurement of colorimetry, for example in CIE XYZ or CIE LAB. The reference substrate may be a white or uncolored substrate and may be a substrate which a printer expects to be used as a default substrate.

Block 804 comprises obtaining a second measurement characterising a color value of an unmarked portion of a colored substrate. The colored substrate may be a different color to the reference substrate, however it may comprise the same material. For example, both the reference substrate and colored substrate may be paper, card, fabric, plastic or textile.

Block 806 comprises predicting a color produced by printing using a first colorant specification on the colored substrate by transforming a color measurement of a color printed using the first colorant specification on the reference substrate to compensate for the color contribution of the reference substrate and to incorporate a color contribution of the colored substrate using the first and second measurements. The transforming may compensate for the color contribution of the reference substrate, for example by a method such as dividing a representation of the color on the reference substrate by a measurement of an unmarked portion of the reference substrate, as described previously. The transformation may incorporate a color contribution of the colored substrate, for example by multiplying by a measurement of an unmarked portion of the colored substrate. Further measurements may also be used to improve the accuracy of the transformation to better predict the color produced by printing using the first colorant specification of the colored substrate.

The additional features described in relation to the flowcharts of FIGS. 3-7 may be used in combination with FIG. 8 to obtain and use, for example, a media independent mapping, a media-independent mapping with media-common correction, a media based least square mapping, a media and CMYK least square mapping or a media and CMYK RBG mapping.

In some examples the method further comprises printing using the first colorant specification on the second colored substrate. The printing may be performed by any suitable printing apparatus. The method may further comprise measuring the printed output. In some examples the measuring may comprise performing a reflectance measurement. For example, the printed sample may be illuminated and detected using an appropriate light sensor. In some examples the light sensor and/or illumination may measure the reflectance at a plurality of different wavelengths.

In some examples the method further comprises determining if the printed output meets at least one predetermined criterion. For example, the predetermined criterion may be a measure of whether the colorimetry of the printed output differs from an expected colorimetry. When the at least one predetermined criterion is met, the method comprises adding the first colorant specification to a color mapping resource associated with the second colored substrate. In this way if the transformation is sufficiently accurate, the mapping may be stored for subsequent use, whereas if the transformation is not sufficiently accurate it may not be stored. Such a measure of colorimetry may additionally be used to recompute a mapping thereby increasing the accuracy in a refinement operation. The predetermined criterion may be based on color differences, such as DE2000 color differences described previously. If the color differences between the printed output and an expected output are greater than a threshold, then the predetermined criterion may be considered not to have been met. In some examples a calibration chart, a profiling chart or a spot color chart may be used as a printed output.

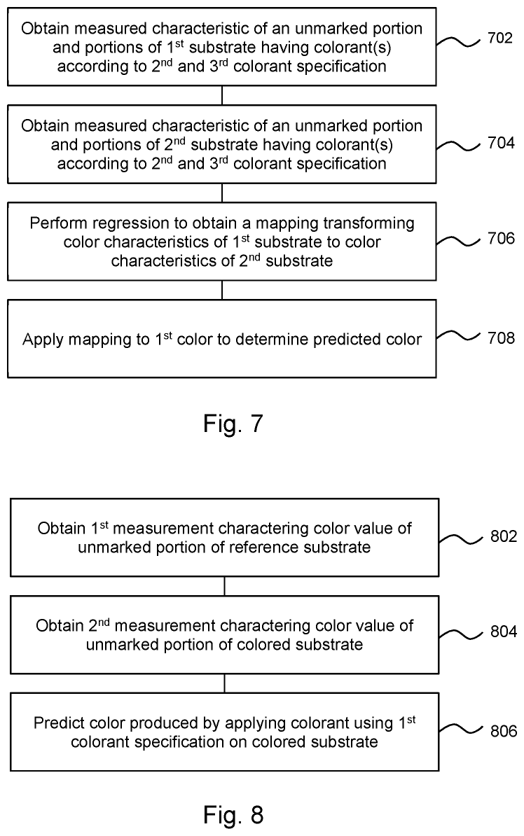

FIG. 9 shows a tangible machine-readable medium 902 associated with a processor 904. The machine-readable medium 902 comprises instructions 906 which, when executed by the processor 904, cause the processor 904 to carry out tasks. In this example, the instructions 906 comprise instructions to cause the processor 904 to generate a color mapping resource. The instructions to generate a color mapping resource comprise instructions 908 to cause the processor 904 to obtain a first measurement characterising a color value of an unmarked portion of a reference substrate.

The instructions to generate a color mapping resource further comprise instructions 910 to cause the processor 904 to obtain a second measurement characterising a color value of an unmarked portion of a colored substrate and instructions 912 to cause the processor 904 to generate a color mapping from a plurality of colors generated using a set of colorant specifications on the reference substrate to a plurality of predicted colors generated using the set of colorant specifications on the colored substrate, wherein the color mapping compensates for the color contribution of the reference substrate and incorporates a color contribution of the colored substrate using the first and second measurements. The color mapping may for example be generated using any of the methods set out above.

The instructions to generate a color mapping resource further comprise instructions 914 to cause the processor 904 to determine a color mapping resource for the colored substrate based on the set of colorant specifications and the predicted colors. The color mapping resource may be a color mapping resource as described in relation to the method of FIG. 7, and in some examples may in generated by interpolating colorant specifications as described above.

In some examples the instructions 906 further comprise instructions to print using the set of colorant specifications on the colored substrate. The instructions may further cause the processor to instruct measuring of the printed output and determine if the printed output meets a predetermined criterion. If the predetermined criterion is met the set of colorant specification may be added to a color mapping resource associated with the colored substrate. For example, the color mapping resource may be a look up table comprising mappings for colorant specifications from the reference substrate to the colored substrate.

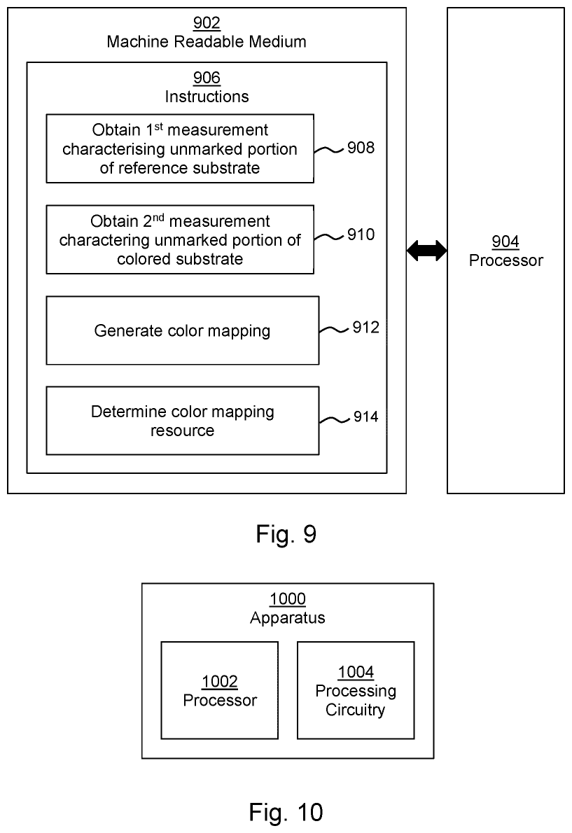

FIG. 10 shows an apparatus 1000 comprising a processor 1002 and a machine readable medium 1004. The machine readable medium 10004 comprises instructions which, when executed by the processor 1002, cause the processor 1002 to carry out any of the blocks of FIG. 1, FIG. 3, FIG. 4, FIG. 5, FIG. 6, FIG. 7 or FIG. 8 or may cause a printing apparatus to carry out any of the blocks of these figures. In some examples the apparatus may be a printing apparatus such as an inkjet printer, a dye-sublimation printer or a liquid electrophotographic (LEP) printer. In other examples the apparatus is associated with a printing apparatus.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
obtaining, by processing circuitry, a mapping from at least one measured color characteristic of a first substrate to at least one measured color characteristic of a second substrate, wherein the at least one measured color characteristic of the first substrate comprises a measured color characteristic of an unmarked portion of the first substrate and the at least one measured color characteristic of the second substrate comprises a measured color characteristic of an unmarked portion of the second substrate; and
applying, by processing circuitry, the mapping to a first color which is obtained when applying at least one colorant according to a first colorant specification on the first substrate to determine a predicted color to be obtained by applying the at least one colorant according to the first colorant specification on the second substrate.

2. A method as claimed in claim 1, wherein the measured color characteristic comprises a measurement of reflectance.

3. A method as claimed in claim 2, wherein the measurement of reflectance is a measurement of reflectance as a function of wavelength.

4. A method as claimed in claim 3 wherein applying the mapping comprises, for a plurality of wavelengths, dividing a reflectance of the first color by the measured reflectance of the first substrate at that wavelength to obtain a substrate independent reflectance.

5. A method as claimed in claim 4, wherein applying the mapping further comprises, for the plurality of wavelengths, multiplying the substrate independent reflectance by the measured reflectance of the second substrate at that wavelength to obtain the predicted reflectance.

6. A method as claimed in claim 1 further comprising:
obtaining, by processing circuitry, a measured color characteristic of an unmarked portion of each of a plurality of different colored substrates;
obtaining, by processing circuitry, a measured color characteristic of at least one printed color patch on each of a plurality of different colored substrates;
obtaining, by processing circuitry, a transformation based on a combination of measured color characteristics of the plurality of different colored substrates.

7. A method as claimed in claim 6, wherein applying the mapping further comprises applying the transformation to the color obtained by applying at least one colorant according to the first colorant specification on the first substrate.

8. A method as claimed in claim 1 comprising obtaining, by processing circuitry, a plurality of measurements of the first and second substrate, and wherein obtaining the mapping comprises performing a regression to obtain the mapping which transforms the measured color characteristic of the first substrate to the measured color characteristic of the second substrate.

9. A method as claimed in claim 8, wherein:
the at least one measured color characteristic of the first substrate comprises a measured characteristic of a portion of the first substrate having colorant(s) applied thereto according to a second colorant specification; and
the at least one measured color characteristic of the second substrate comprises a measured characteristic of a portion of the second substrate having colorant(s) applied thereto according to the second colorant specification.

10. A method as claimed in claim 9, wherein the second colorant specification specifies generation of a colored patch comprising a single color of colorant.

11. A method as claimed in claim 10, wherein:
the at least one measured color characteristic of the first substrate comprises a measured characteristic of a portion of the first substrate having colorant(s) applied thereto according to a third colorant specification; and
the at least one measured color characteristic of the second substrate comprises a measured characteristic of a portion of the second substrate having colorant(s) applied thereto according to the third colorant specification; and
wherein the third colorant specification instructs printing of a patch using a plurality of colors.

12. A method as claimed in claim 1 comprising:
applying colorant(s) according to the first colorant specification on the second substrate;
measuring at least one color characteristic of the colored output; and
determining a color mapping resource for printing on the second substrate based on the measured color characteristic and the first colorant specification.

13. A method comprising:
obtaining, at a processor, a first measurement characterising a color value of an unmarked portion of a reference substrate and obtaining a second measurement characterising a color value of an unmarked portion of a colored substrate; and
predicting, by the processor, a color produced by applying colorant according to a first colorant specification on the colored substrate by transforming a color measurement of a color generated by applying colorant according to the first colorant specification on the reference substrate to compensate for the color contribution of the reference substrate and to incorporate a color contribution of the colored substrate using the first and second measurements.

14. A method as claimed in claim 13 further comprising:
printing using the first colorant specification on the colored substrate;
measuring the printed output;
determining if the printed output meets at least one predetermined criterion; and
when the at least one predetermined criterion is met, adding the first colorant specification to a color mapping resource associated with the colored substrate.

15. A machine readable medium comprising instructions which, when executed by a processor, cause the processor to:
generate a color mapping resource by:
obtaining a first measurement characterising a color value of an unmarked portion of a reference substrate and obtaining a second measurement characterising a color value of an unmarked portion of a colored substrate;
generating a color mapping from a plurality of colors generated using a set of colorant specifications on the reference substrate to a plurality of predicted colors generated using the set of colorant specifications on the colored substrate, wherein the color mapping compensates for the color contribution of the reference substrate and incorporates a color contribution of the colored substrate using the first and second measurements; and
determining a color mapping resource for the colored substrate based on the set of colorant specifications and the predicted colors.
